(19) United States
(12) Patent Application Publication
(10) Pub. No.: US 2007/0035510 A1
(43) Pub. Date: Feb. 15, 2007

(54) Reset pulse driving for reducing flicker in an electrophoretic display having intermediate optical states

(75) Inventors: Guofu Zhou, Eindhoven (NL); Leendert Marinus Hage, Eindhoven (NL); Rogier Hendrikus Magdalena Cortie, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/573,551

(22) PCT Filed: Sep. 20, 2004
(86) PCT No.: PCT/IB04/51796

§ 371 Date: Mar. 27, 2006

(30) Foreign Application Priority Data
Sep. 30, 2003 (EP) 03103616.3

(51) Int. Cl. G09G 3/34

(52) U.S. Cl. 345/107

(57) ABSTRACT

The present invention relates to a novel driving scheme for an electrophoretic display providing accurate intermediate optical states. According to the invention, the level of remnant voltage across pixels are taken into account when driving the display. Remnant voltage is built up when resetting the pixel between consecutive image states, and the reset states are therefore chosen so as to avoid the generation of excessive remnant voltage levels. The invention can for example be implemented using a counter, counting the number of consecutive uses of the same state as extreme state, or using a look-up-table in which driving history of the display is mapped and which determines the reset state to be used for the next reset based on the driving history. In effect, the threshold number of consecutive uses of the same state as a reset state is avoided.

The present invention relates to electrophoretic displays, and in particular to the driving of such displays.

Electrophoretic displays are known since long, for example from U.S. Pat. No. 3,612,758. The fundamental principle of electrophoretic displays is that the appearance of an electrophoretic media encapsulated in the display is controllable by means of electrical fields. To this end the electrophoretic media typically comprises electrically charged particles having a first optical appearance (e.g. black) contained in a fluid such as liquid or air having a second optical appearance (e.g. white), different from the first optical appearance. The display typically comprises a plurality of pixels, each pixel being separately controllable by means of separate electric fields supplied by electrode arrangements. The particles are thus movable by means of an electric field between visible positions, invisible positions, and possibly also intermediate semi-visible positions. Thereby the appearance of the display is controllable. The invisible positions of the particles can for example be in the depth of the liquid or behind a black mask.

A more recent design of an electrophoretic display is described by E Ink Corporation in, for example, WO99/53373. Electrophoretic medias are known per se from e.g. U.S. Pat. No. 5,961,804, U.S. Pat. No. 6,120,839, and U.S. Pat. No. 6,130,774, and can be obtained from, for example, E Ink Corporation.

Grayscales or intermediate optical states in electrophoretic displays are generally provided by applying voltage pulses to the electrophoretic media for specified time periods. The implementation of grayscales in electrophoretic displays is however connected with a number of problems. A fundamental problem is that it is very difficult to accurately control and keep track of the actual positions of the particles in the electrophoretic media, and even minor spatial deviations might result in visible grayscale disturbances.

Typically, only the extreme states are well defined (i.e. the states where all particles are attracted to one particular electrode). In case a potential is applied forcing the particles towards one of the extreme states, all the particles will for sure be collected in that particular state if the potential is applied long enough. However, in intermediate states (gray levels) there will always be a spatial spread among the particles, and their actual positions will depend upon a number of circumstances which can be controlled only to a certain degree. Consecutive addressing of intermediate gray levels is particularly troublesome. In practice, the actual grayscale is strongly influenced by image history (i.e. the preceding image transitions), the waiting time or the un-powered image holding time (i.e. the time between consecutive addressing signals), temperature, humidity, lateral non-homogeneity of the electrophoretic media etc.

It is therefore highly desirable to provide electrophoretic displays offering more well defined gray levels or intermediate optical states when color particles are used.

According to the co-pending European application EP02079203.2 (PHNL021000) the gray level accuracy can be improved using a rail-stabilized approach, which means that the gray levels are always addressed via a well defined reset state, typically one of the extreme states (i.e. rails). The benefit of this approach is that the extreme states are stable and well defined, as opposed to the less well defined intermediate states. The extreme states are thus used as reference states for each grayscale transition.

Theoretically the uncertainties in each gray level therefore depend only upon the actual addressing of that particular gray level, since the initial position is well known.

However, using this approach grayscale transitions become visible as flicker, since a transition from one gray level to another includes an intermediate phase where the pixel is in one of the extreme states. This flickering effect can be reduced in case the reset state is chosen to be the particular extreme state that is closest to the previous and/or subsequent states.

For example, in a black and white display the reference initial rail state for a grayscale transition is chosen according to the gray level desired. The gray levels between full white (100% bright) and middle gray (50% gray) are achieved starting from the reference white state and the gray levels between full dark (0%) and the middle gray (50% gray) are achieved starting from the reference black state. The advantage of this method is that an accurate gray scale can be addressed with minimal visibility and reduced image update time.

According to the above principle each grayscale transition thus includes a reset pulse, resetting the pixel in the respective extreme state, and an addressing pulse, setting the pixel in the desired grayscale state. Theoretically, the duration of a reset pulse only needs to be the time that is required for the particles to travel from the present state to one of the extreme states. However, using such a limited reset pulse does not actually reset the pixel completely. As it turns out, the appearance of the pixel still depend to some degree upon the addressing history of the pixel.

Therefore, the co-pending European application EP 03100133.2 (PHNL030091), proposes a further improvement by the use of an over-reset voltage pulse, extending the duration of the reset pulse. The reset pulse thereby consists of two portions: a “standard reset” portion and an “over-reset” portion. The “standard reset” requires a time period that is proportional to the distance between the present optical state and the extreme state. The “over-reset” is needed for erasing pixel image history and improving the image quality.

Using the reset pulse, the pixels are first brought into one of two well-defined limit states before the drive pulse changes the optical state of the pixel in accordance with the image to be displayed. This improves the accuracy of the grey levels. The “over-reset” pulse and the “standard reset” pulse together have an energy which is larger than required to bring the pixel into the extreme state. The duration of the over-reset pulse may depend on the required transition of the optical state.

Unless explicitly mentioned, for the sake of simplicity, the term reset pulse may cover both the reset pulse without the over-reset pulse or the combination of the reset pulse and the over-reset pulse.

However, using this solution the total reset period is always longer than the time period in the gray scale driving pulse, leading to net remnant DC on the pixel. The remnant DC is built up in the display media, e.g. the ink layer, binders, and adhesives. This remnant DC has to be timely removed or reduced to avoid gray scale drift in the subsequent image updates. In case the reset state continuously shifts between the two extreme states, the drift problem is substantially eliminated since the integral remnant DC is automatically kept close to zero. However, in practice, the image sequences are often not random and dark gray to dark gray or light gray to light gray transitions may occur repeatedly. The remnant DC is then integrated over time on the pixel with an increased number of consecutive image transitions via the same extreme state, leading to a large drift in grayscale towards that particular extreme state in subsequent image transitions. The probability of having these repetitions is particularly high if the display has a large number of gray levels.

To this end the present invention proposes a novel method for driving an electrophoretic display, providing for largely reduced gray scale drift introduced by remnant DC on the pixel. During a grayscale image transition, the closest extreme state (e.g. black or white) is normally chosen as the reset state, similar to the above principle. But, according to the present invention, the opposite extreme state is chosen as the reset state when one or more previous image transitions are realized via the same extreme state.

Thus, according to one aspect of the invention, an electrophoretic display device is provided. The display device comprises at least one pixel cell and drive means for driving said at least one pixel cell between a first extreme state, a second extreme state and at least two intermediate states. The drive means is operative to drive each pixel by means of a drive signal comprising a reset signal setting the pixel in a selected reset state, and an address signal setting the pixel in a target image state. The display device further comprises means for estimating a level of remnant voltage in each pixel, and the reset state is selected as one of said extreme states depending on the target image state and depending on the estimated level of remnant voltage. Thereby excessive remnant voltage levels are avoided and flicker occurring due to different optical appearance of the target image state and the selected reset state is limited.

The invention is thus advantageous in that measures are taken to reduce the gray scale drift otherwise occurring due to the build up of a net remnant DC in the pixel.

According to one aspect of the present invention, the number of consecutive uses of the same extreme state as reset state is regarded as a measure for the integral remnant DC on the pixel, and the opposite extreme state is used in order to cancel that remnant DC.

From a flicker reducing point of view, a flicker minimizing reset state can typically be chosen as the particular extreme state that introduces the least amount of perceivable flicker, e.g. the extreme state that is closest for the gray state transition at hand. Of course, for some transitions there might not be a well defined flicker minimizing reset state, e.g. two different extreme states might introduce the same amount of flicker. For the purpose of the present invention, i.e. for reducing the net remnant DC, either of such states might be regarded as the flicker minimizing reset state. The flicker minimizing reset state is typically the first hand choice in case the build up of remnant DC is not an issue. However, taking the build up of remnant DC into account, a tradeoff has to be made between flicker at one hand and increased remnant DC on the other hand. There are several ways to perform this tradeoff. In one extreme, the build up of remnant DC is not prioritized, and the driving thus focuses primarily on reducing the flicker. In the other extreme, the build up of remnant DC is prioritized and the reset state is thus primarily chosen so as to eliminate that effect. In the most extreme case, the same extreme state is never used more than once in consecutive transitions. In a display having only two extreme states, this results in each extreme state being used as reset state every other addressing cycle.

According to one embodiment, the drive means comprises a look-up table (LUT) and is operative to determine a desired flicker minimizing reset state, to store information regarding preceding driving signals, and to pick the reset signal from said look-up table based on said desired flicker minimizing reset state and on said preceding reset states. The look-up table can have many different designs. A simple look-up table might, for example, take only the most recent driving history into account. In such case, the reset state used depends only on the previous reset state and on the presently desired flicker minimizing reset state. More complex look-up tables are however envisaged as well, taking a longer addressing history and possibly also other factors influencing the performance of the display into account, for examples measures of actual remnant DC. However, a more complex look-up table typically results in a more complex and thus expensive device.

According to another embodiment, the drive means is operative to count the number of consecutive times one particular extreme state is used as reset state, and to use another extreme state in case a predetermined threshold value is reached. This embodiment is relatively simple to implement, since only a limited number of look-up tables is required (specifying alternative drive signals). Instead, the number of consecutive uses of the same extreme state is counted, for example by a counter, and the inventive change of reset state is only activated in case a predetermined threshold value is reached. Thus, as long as the number of consecutive uses of the same extreme state is below the threshold value, driving of the display is performed in much the same way as in a display not implementing the present invention.

One approach for the tradeoff between flicker and remnant DC is to exclude the intermediate states (gray levels) that is most critical for flicker, typically those closes to the extreme states (e.g. very dark gray and very light gray in a black and white display). Thus, according to one embodiment, the image states include at least three intermediate states, and the reset states of the intermediates states that are closest to the extreme states are independent of said preceding reset states. For example, according to this embodiment, in a black and white display having a large number of gray level transitions from the most dark gray level to the second most dark gray level would always use the black extreme state as reset state, independent of previous addressing history. But, for transitions close to the middle gray levels the number of consecutive uses of the same extreme state as reset state is limited. This embodiment is thus advantageous in that the most flicker critical transitions are always performed in a flicker reducing way, whereas transitions not as critical for flicker are used for reducing the remnant DC. In order to compensate for the thereby increased integral remnant DC, reset states for the less flicker sensitive transitions can prioritize the build up of remnant DC (e.g. the threshold value is decreased or the look-up table is adjusted correspondingly).

Another aspect of the present invention provides a method of driving an electrophoretic display device comprising at least one pixel cell which is controllable between different image states including a first extreme state, a second extreme state, and at lest two intermediate states. The method comprises the steps of:

receiving pixel image information regarding a target image state to be displayed by the pixel;

estimating a level of remnant voltage in the pixel cell,

resetting the pixel to a selected reset state by means of a reset signal,

switching said pixel from said selected reset state to said target image state,

wherein, said selected reset state is selected as one of said extreme states depending on the target image state and depending on the estimated level of remnant voltage, such that excessive remnant voltage levels are avoided while simultaneously limiting flicker occurring due to different optical appearance of the target image state and the reset state.

According to still one aspect, the invention provides a computer program implementing the above method of driving an electrophoretic display. Such a computer program can, for example, be implemented in a drive unit of a corresponding display device.

In the following, the present invention will be further described with reference to the accompanying, exemplifying drawings, on which:

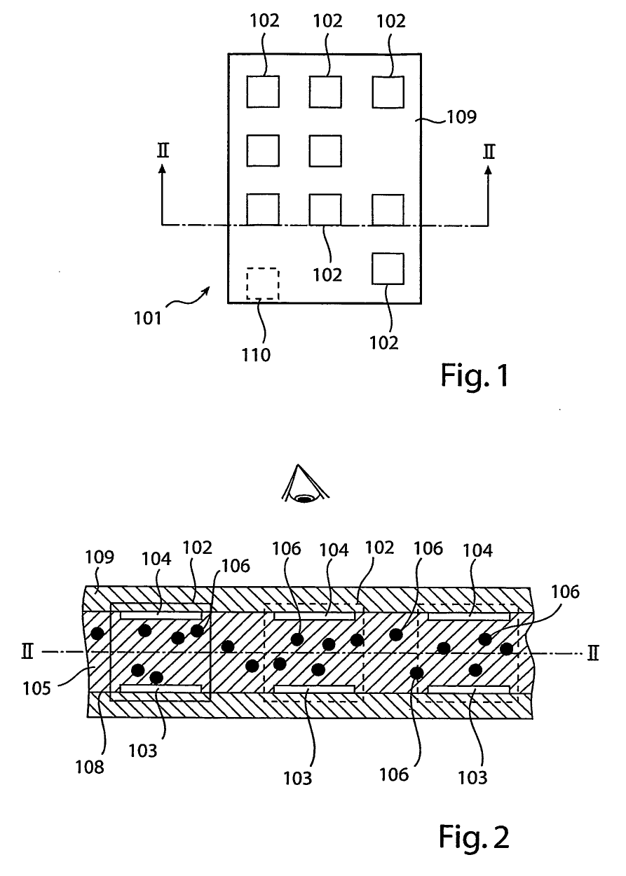

FIG. 1 is a schematic top view of an electrophoretic display unit;

FIG. 2 is a schematic cross section of the display unit of FIG. 1;

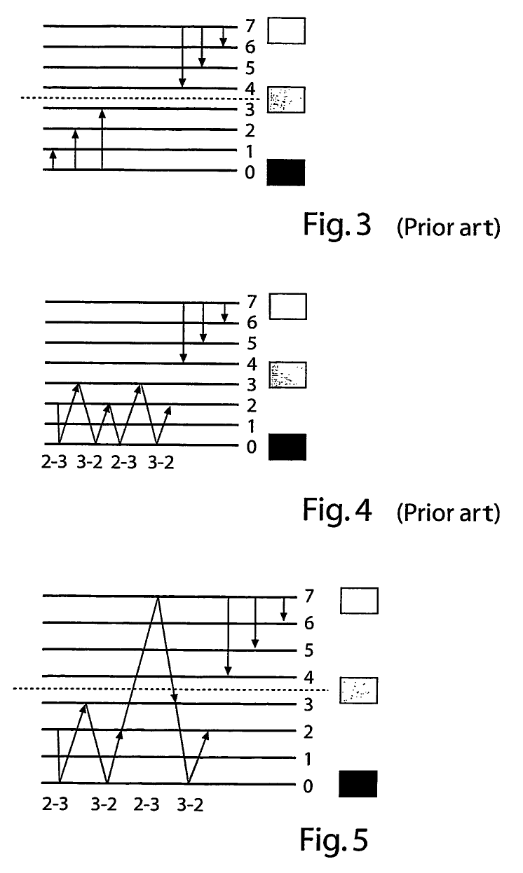

FIG. 3 illustrates gray level states in a display unit having 8 gray levels;

FIG. 4 illustrates gray level transitions not implementing the present invention;

FIG. 5 illustrates the same transitions as FIG. 4, but implementing the present invention;

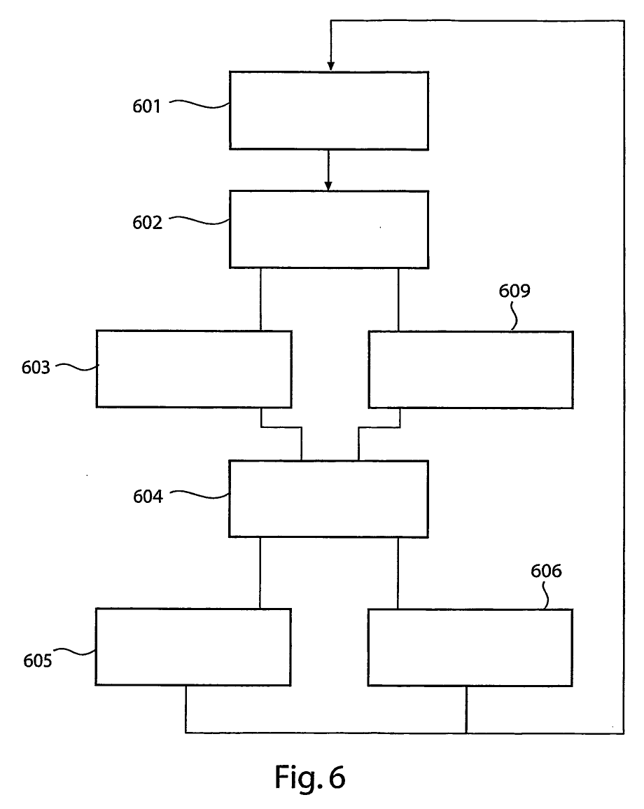

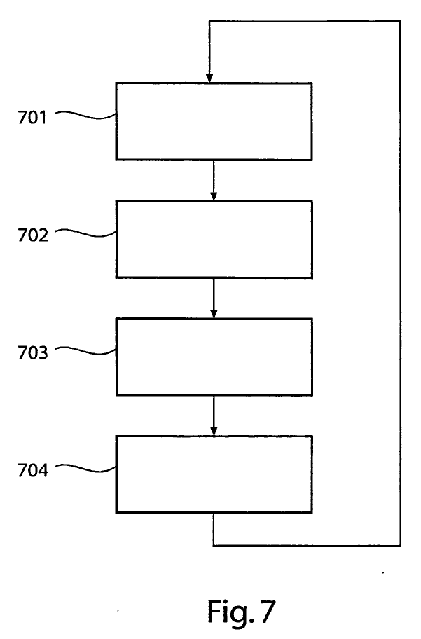

FIGS. 6 and 7 are flowcharts illustrating different implementations of the present invention; and

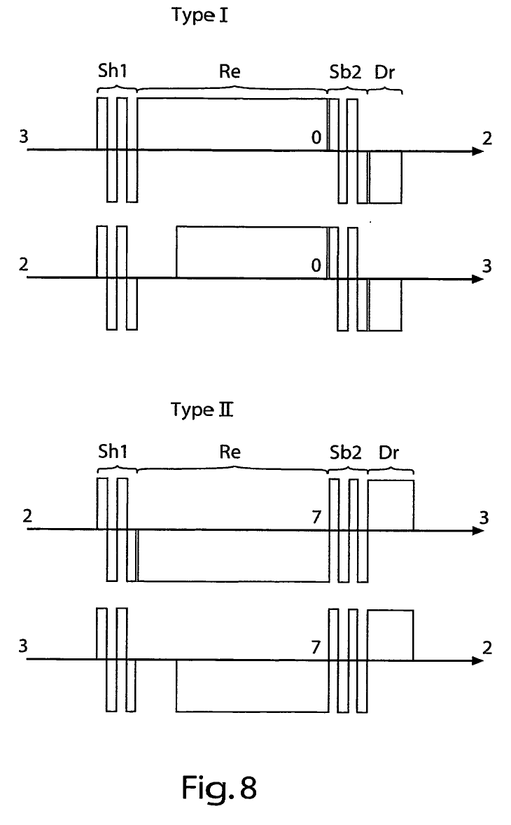

FIG. 8 illustrates two different drive signal waveforms (type I and type II) for the same transitions according to the present invention.

First, the fundamental principles of electrophoretic displays will be further described with reference to FIGS. 1 and 2. Thus, FIGS. 1 and 2 show a top view and a cross section, respectively, of an electrophoretic display panel 101 comprising a backside substrate 108, a front side substrate 109, and a plurality of pixels 102. The pixels 102 are arranged along substantially straight lines in a two-dimensional configuration. However, other arrangements of the pixels are of course possible. The device further comprises a drive means 110 for driving the display.

The back and front side substrates 108, 109 are arranged parallel to each other and encapsulate an electrophoretic medium 105. The substrates can for example be glass plates, and it is important for at least the front side substrate 109 to be transparent in order to display a visible image. Each pixel is defined by the overlapping areas of line electrodes and row electrodes 103, 104 arranged along respective substrates. For example, the line electrodes 104 might be arranged on the front side substrate 109 and the row electrodes 103 are in such case arranged along the backside substrate 109. The electrodes are preferably formed out of ITO (Indium Tim Oxide), but other electrode materials are also possible. In the configuration shown in FIGS. 1 and 2, it is however important for the electrodes arranged on the front side substrate to be transparent, not to interfere with the displayed image of the pixel.

The electrophoretic medium 105 provides each pixel 102 with an appearance, being one of a first and a second extreme appearances (state) and intermediate appearances (states) between the first and the second appearances. Depending on the color composition of the electrophoretic medium, the first extreme appearance might for example be black and the second appearance might be white. In such case the intermediate appearances are various degrees on a grayscale. However, the extreme appearances might alternatively be different, preferably opposing colors (e.g. blue and yellow, the intermediate appearance then being various degrees of greenish).

Alternative configurations, having the electrodes arranged outside the actual pixel area are also envisaged, and does not require the electrodes to be transparent. For example, the electrodes may in certain embodiments be used to move the particles in a direction paralell to the plane of the substrates. In an active matrix embodiment, each pixel 102 further comprises switching electronics (not shown) on per se known manner, comprising for example thin film transistors (TFTs), diodes or Metal-Insulator-Metal (MIM) devices.

According to one embodiment, the electrophoretic medium 105 comprises negatively charged black particles 106 in a white fluid. When charged particles 106 are positioned near the backside electrode 103 by a potential difference of e.g. 15 Volt, the pixel 102 has a first extreme appearance (i.e. white). When the charged particles 6 are positioned near the front side electrode, the display instead has a dark appearance.

Now, consider a black and white electrophoretic display having six states: black, very dark gray, dark gray, light gray, very light gray, and white. Transition from dark gray to very dark gray normally uses the black state as reset state, since the black state is closest to the transition states. However, according to the present invention, consecutive use of the black state as reset state for transitions between the two dark gray states is avoided. This can be achieved, for example, by reducing the maximum number of consecutive uses of the same extreme state as reset state. More ingenious principles can be implemented in a look-up table.

The use of look-up-tables (LUTs) provides more flexibility when controlling the reset state in order to reach a balance between the image flickering and remnant DC. But LUTs usually require more memory when more flexibility is implemented.

The threshold approach requires only a limited number of look-up-tables (e.g. one for a normal drive waveform and one for a drive waveform canceling remnant DC when the threshold number is reached). The memory requirement is thus reduced using the threshold approach, resulting in less expensive products.

In FIG. 3 the gray level states of a black and white display providing a black (0), a white (7), and six intermediate gray levels (1-6) are illustrated. The arrows indicate the flicker reducing reset state for the respective gray level (states 1-3 having state 0 as flicker reducing reset state and states 4-6 having state 7 as flicker reducing state). Furthermore, FIG. 4 illustrates addressing signals for the consecutive addressing of states 2-3-2-3-2. As can be seen, state 0 is repeatedly used as reset state minimizing flicker but also resulting in the build up of remnant DC.

FIG. 5 instead illustrates an example of the approach suggested by the present invention. Thus, after two consecutive uses of state 0 as reset state, state 7 is used instead. This results in somewhat increased flicker, but also in a substantial reduction of the integral remnant DC.

It has been experimentally demonstrated that the grayscale shift (i.e. the net remnant DC) is massively reduced using the present invention. The experiments were done for a display with 8 gray levels, grayscale accuracy was largely improved and the absolute grayscale position remained (i.e. essentially no level shift). This is extremely important for achieving an increased number of grayscales.

Basically, the implementation of the present invention can be incorporated in the drive unit of the display. Compared to ordinary drive units, an inventive drive unit must be able to store addressing history and to decide the most appropriate reset state partly based on the addressing history. This type of modifications can be made in many different ways, well know to persons skilled in the art. For example, in case the drive unit is based on an Application Specific Integrated Circuit (ASIC), the inventive driving is easily implemented in that ASIC.

FIG. 6 is a flowchart, illustrating the operation of a drive unit in an inventive display unit using a threshold value. The drive unit thus inputs 601 image information regarding which state the pixel is to be updated to. Thereafter the number of preceding, consecutive uses of the same extreme state as reset state is checked 602. In case this number exceeds the threshold number, the opposite extreme state is used 603 as reset state. In case the threshold number is not yet reached, the desired flicker reducing reset state is determined and used 600. Since the threshold number was not reached, the driving history (and thus the existence of any remnant DC) is not considered. Thereafter the extreme state used as reset state is compared 604 to the extreme state previously used and stored in a counter. In case the same extreme state is used again, the counter is increased 605 one unit, and if the opposite extreme state is used the counter is instead reset 606.

FIG. 7 is a flowchart, illustrating the operation of a drive unit in an inventive display unit using a look-up table. The drive unit thus inputs 701 image information regarding the desired state, i.e. which state the pixel is to be updated to. Thereafter the desired, flicker reducing reset state is determined 702, based on the present state and the desired state. Next the extreme state to be used as reset state is picked 703 from the look-up table, based on the desired flicker minimizing reset state and preceding addressing history. Finally, the extreme state used as reset state and/or the image information is stored 704 in a memory unit.

In an alternative arrangement, the look-up table instead takes the image information as input, and gives the extreme state to be used based on that information. Thereby the step 702 of determining the desired reset state can be eliminated. Of course, there are a large number of various implementations using a look-up table available to the skilled man.

The complete voltage waveform which has to be presented to a pixel during an image update period is referred to as the drive voltage waveform. The drive voltage waveform usually differs for different optical transitions of the pixels.

According to the present invention, two types of drive waveforms can be used for the same type of grayscale image transition as schematically shown in FIG. 8 for a transition from state 2 to state 3 and from state 3 to state 2. Type I waveform is usually used but type II waveform is chosen when the number of repetitions of grayscale transitions from the same rail is beyond 1. For example, each waveform can consists of shaking 1, reset, shaking 2, and driving pulses as proposed in. The shaking pulses increases the mobility of the particles such that the subsequent reset (or drive) pulse has an immediate effect. The shaking pulse might comprise only one voltage puls or a number of voltage pulses, and can be applied before the drive pulses and/or before the reset pulses. The shaking pulse has an energy (or a duration if the voltage level is fixed) sufficient to release particles present in one of the extreme states, but insufficient to enable the particles to reach the other one of the extreme positions.

Thus, in case the present invention is implemented in the form of look-up-table (LUT), each grayscale transition requires one drive waveform which is created following the conventional “closest rail principle”, i.e. when the driving history of the pixel is not considered, and one drive waveform when the driving history is considered. When only one previous optical state is considered in a display having 4 possible optical states e.g. black (0), dark gray (1), light gray (2) and white (3), there can be four LUTs for each transition according to this invention. Conventionally only one LUT would be used for each transition, not considering the pixel image history or driving history. For example, for a transition from level 1 to level 1 with image history 0, 1, 2, and 3, respectively (i.e. 011, 111, 211, and 311). The LUT for 011 and/or 111 transitions uses type II waveforms and 211 an/or 311 uses type I waveforms.

In case the present invention is realized by a counter and a threshold number, type I waveforms can be used when the number of repetitions is below the threshold number and type II waveforms when the threshold number is reached. The same procedure is repeated for each transition. For example, in case the threshold number is set to 1, type II waveforms can at most be used every second transition (in case the same grayscale is addressed continuously). In case the threshold number is set to 3, type II waveforms can at most be used every fourth transition.

Accordingly, dual look-up-tables may be predefined. One of them is used for building the drive waveform according to the reset flicker reducing, closest extreme state principle and the other is reset to the opposite rail. The choice of the LUTs is determined by the image history and the driving history.

The use of a look-up table, compared to a counter and threshold value, typically provides improved reduction of remnant DC but also somewhat increased complexity. Still one alternative is to use a computer unit, which is arranged to continuously calculate the most beneficial reset state. Apart from the image information, such a computer can take a number of different variables as input, such as previous image history on the pixel, integrated DC on the pixel and image update time.

For the purpose of the present invention, the wording extreme state is to be interpreted as a well defined state wherein the distribution of the particles in the electrophoretic media can be accurately predetermined. A pixel can have two states, e.g. opposing black and white states, but could alternatively have more than two states. Additional extreme states can be defined for example by the inclusion of additional electrodes. Thus, the invention is equally applicable to pixels having more than two extreme states.

From the above, the advantage of this invention is obvious—reducing grayscale drift/shift and improving grayscale accuracy. This is crucial for the implementation of high bits such as 4-bits grayscale solutions.

A novel method is proposed for driving an electrophoretic display with improved grayscale accuracy and with largely reduced grayscale drift that is introduced by the remnant DC on the pixel. During a grayscale image transition, the closest rail (e.g. the black or the white rail) is conventionally chosen as the reset state.

The present invention is applicable to any bi-stable displays including various types of electrophoretic displays. Any driving schemes such as pulse-width modulated or voltage modulated driving or their combination may be used. The electrode structures are not limited to any particular design; top-bottom electrodes or honeycomb structures may be used. In the above examples, the shaking pulse may be optional in the ink systems less sensitive to the image history.

In essence, the present invention relates to a novel driving scheme for an electrophoretic display providing accurate intermediate optical states. According to the invention, the level of remnant voltage across pixels are taken into account when driving the display. Remnant voltage is built up when resetting the pixel between consecutive image states, and the reset states are therefore chosen so as to avoid the generation of excessive remnant voltage levels. The invention can for example be implemented using a counter, counting the number of consecutive uses of the same state as extreme state, or using a look-up-table in which driving history of the display is mapped and which determines the reset state to be used for the next reset based on the driving history. In effect, the number of consecutive uses of the same state as reset state is avoided.

1. An electrophoretic display device (101) comprising at least one pixel cell (102) and drive means (110) for driving said at least one pixel cell (102) between a first extreme state, a second extreme state and at least two intermediate states; said drive means (110) being operative to drive each pixel cell by means of a drive signal comprising a reset signal setting the pixel in a selected reset state, and an address signal setting the pixel in a target image state; said display device (101) further comprising means (110) for estimating a level of remnant voltage in each pixel; and said selected reset state being selected as one of said extreme states depending on the target image state and depending on the estimated level of remnant voltage, such that excessive remnant voltage levels are avoided while simultaneously limiting flicker occurring due to different optical appearance of the target image state and the selected reset state.

2. An electrophoretic display device (101) according to claim 1, wherein said means (110) for estimating a level of remnant voltage comprises a counting means, operative to count the number of consecutive times the same extreme state is selected as reset state.

3. An electrophoretic display device (101) according to claim 2, wherein the number of consecutive times the same extreme state is selected as reset state is limited to a pre-determined threshold number, and wherein a different extreme state is selected in case the threshold number is reached.

4. An electrophoretic display device (101) according to claim 1, wherein the drive means (110) comprises a look-up table and is operative to determine a desired flicker minimizing reset state, to store information regarding preceding driving signals, and to select the reset signal from said look-up table based on said desired flicker minimizing reset state and on said preceding driving signals.

5. An electrophoretic display device (101) according to claim 1, wherein said intermediate states includes a first intermediate state having an optical appearance that is close to said first extreme state, and wherein said first extreme state is always selected as reset state when said first intermediate state is used as target image state, such that flicker is limited without considering the build up of remnant voltage when addressing said first intermediate state.

6. A method of driving an electrophoretic display device, said display device comprising at least one pixel cell which is controllable between different image states including a first extreme state, a second extreme state, and at lest two intermediate states; said method comprising the steps of:
receiving (601; 701) pixel image information regarding a target image state to be displayed by the pixel;
estimating (602; 703) a level of remnant voltage in the pixel cell,
resetting the pixel to a selected reset state by means of a reset signal,
switching said pixel from said selected reset state to said target image state,
wherein, said selected reset state is selected as one of said extreme states depending on the target image state and depending on the estimated level of remnant voltage, such that excessive remnant voltage levels are avoided while simultaneously limiting flicker occurring due to different optical appearance of the target image state and the reset state.

7. A method according to claim 6, wherein said step of estimating (602; 703) a level of remnant voltage takes a driving history of the display device into account.

8. A method according to claim 6, wherein said step of estimating (602) a level of remnant voltage includes the step of counting (602) the consecutive number of times the same extreme state has been used as reset state.

9. A method according to claim 6, said method further comprising the step of
determining (702) a desired flicker minimizing reset state,
storing (704) information regarding preceding driving signals, and
selecting (703) said reset signal from a look-up table, based on based said desired flicker minimizing reset state and on said preceding driving signals.

10. A computer program implementing the method of claim 6.
